(19) United States
(12) Patent Application Publication
(10) Pub. No.: US 2020/0259207 A1
(43) Pub. Date: Aug. 13, 2020

(54) LITHIUM-SULFUR RECHARGEABLE BATTERY

(71) Applicant: QATAR FOUNDATION FOR EDUCATION, SCIENCE AND COMMUNITY DEVELOPMENT, Washington, DC (US)

(72) Inventors: MARINE BEATRICE CUISINIER, DOHA (QA); ALI ABOUIMRANE, DOHA (QA); ILIAS BELHAROUAK, DOHA (QA)

(73) Assignee: QATAR FOUNDATION FOR EDUCATION, SCIENCE AND COMMUNITY DEVELOPMENT, DOHA (QA)

(21) Appl. No.: 16/647,014

(22) PCT Filed: Sep. 11, 2018
(86) PCT No.: PCT/US2018/050523

§ 371 Date: Mar. 12, 2020

Related U.S. Application Data
(60) Provisional application No. 62/557,592, filed on Sep. 12, 2017.

(51) Int. Cl. H01M 10/0525; H01M 4/60; H01M 4/505; H01M 4/525; H01M 4/136; H01M 4/62; H01M 4/133

(52) U.S. Cl. CPC H01M 10/0525; H01M 4/602; H01M 4/505; H01M 4/133; H01M 4/136; H01M 4/621; H01M 4/525

(57) ABSTRACT

The lithium-sulfur rechargeable battery (10) includes a negative electrode (14) formed from a composite of sulfurized polyacrylonitrile (SPAN), carbon black and carbon nanofibers coated on an aluminum substrate. The negative electrode (14), a corresponding positive electrode (16), an electrolyte (20) and a separator (18) are each disposed within a cell housing (12). The positive electrode (16) is formed from an alkali metal, an alkaline earth metal or salts thereof. The alkali metal of the positive electrode (16) may be, for example, lithium, sodium, potassium or cesium, and the alkaline earth metal of the positive electrode (16) may be, for example, magnesium, calcium or barium. Alternatively, the positive electrode (16) may be formed from aluminum, silver, zinc, hydrogen or salts thereof. The electrolyte (20) is formed from an alkali metal salt dissolved in an organic solvent.

### TECHNICAL FIELD

The disclosure of the present patent application relates generally to rechargeable batteries, and particularly to a lithium-sulfur rechargeable battery having a sulfurated composite material (referred to herein as SPAN) as the negative electrode material and a high-voltage alkali intercalation material as the positive electrode.

### BACKGROUND ART

There is great interest in lithium-sulfur (Li/S) rechargeable batteries, due primarily to their high theoretical capacity 1672 mA h/g and energy density 2500 W h/kg. Sulfur (S) is normally considered as the positive electrode material, with metallic lithium used as the negative electrode. The high capacity is based on the conversion reaction of elemental sulfur to form the lithium sulfide (Li₂S) by reversibly incorporating two electrons per sulfur atom at an electrochemical potential around 2.1 V vs. Li⁺/Li. This is an order of magnitude higher than that of current commercial lithium-ion technology. Unfortunately, Li/S batteries presently have major shortcomings that prevent them from being commercialized.

Sulfur is a highly insulating element and needs conductive electron additives, such as carbon fiber or carbon black, to make it feasible as an electrode material, thus decreasing the practical energy density that can be obtained from the system. Additionally, the intermediate lithium polysulfides formed during battery cycling are soluble in the electrolyte and can diffuse or migrate to the lithium negative electrode, which induces the so-called “shuttle mechanism” within the electrochemical cell.

The formation of soluble, strongly nucleophilic intermediates during charge and discharge between sulfur and Li₂S is the main cause of Li/S battery failure and the main impediment for its commercialization.

Thus, a lithium-sulfur rechargeable battery solving the aforementioned problems is desired.

### DISCLOSURE

The lithium-sulfur rechargeable battery is a secondary battery that includes a negative electrode formed from a composite of sulfurated polyacrylonitrile (SPAN), carbon black and carbon nanofibers coated on an aluminum substrate. The positive electrode is a strongly oxidizing intercalation material (e.g., a layered compound or spinel structure, or orthophosphates) formed from an alkali metal, an alkaline earth metal, or salts thereof. The alkali metal of the positive electrode may be, for example, lithium, sodium, potassium or cesium, and the alkaline earth metal of the positive electrode may be, for example, magnesium, calcium or barium. Other metals that might be used in the positive electrode include aluminum, silver, and zinc. Potentially, even hydrogen might be used. The metal of the positive electrode is selected such that the positive active material thereof has an electrochemical potential of at least 4.0 V relative to the alkali metal, and more preferably at least 4.5 V relative to the alkali metal. The electrolyte is formed from an alkali metal salt dissolved in an organic solvent. The alkali salt may be, for example, a lithium salt, a sodium salt, a potassium salt or a cesium salt. The positive and negative electrodes, an electrolyte, and a separator are each disposed within a cell housing.

These and other features of the present disclosure will become readily apparent upon further review of the following specification and drawings.

### BRIEF DESCRIPTION OF THE DRAWINGS

FIG. 1 is a schematic diagram of a lithium-sulfur rechargeable battery.

FIG. 2A is a plot comparing the capacity cycling performance of a rechargeable battery (SPAN/NCA) having a SPAN negative electrode and a lithium-nickel-carbon-aluminum (LiNi_{0.8}Co_{0.15}Al_{0.05}O₂) positive electrode against the capacity cycling performance of a conventional prior art rechargeable battery (Li/SPAN) having a lithium negative electrode and a SPAN-positive electrode.

FIG. 2B is a plot comparing the capacity cycling performance of a rechargeable battery having a lithiated graphite (LiₓC) negative electrode and a SPAN positive electrode (LiₓC/SPAN), against the capacity cycling performance of the conventional prior art rechargeable battery with a lithium negative electrode and a SPAN-based positive electrode (Li/SPAN).

FIG. 3A is a plot showing the galvanostatic profile for a rechargeable battery having a metallic lithium negative electrode and a SPAN positive electrode (SPAN/Li).

FIG. 3B is a plot showing the galvanostatic profile for a rechargeable battery having a SPAN negative electrode and a lithium-nickel-carbon-aluminum (LiNi_{0.8}Co_{0.15}Al_{0.05}O₂) positive electrode (NCA/SPAN).

FIG. 4A is a plot comparing the specific capacity between a conventional prior art rechargeable battery having a LiNi_{0.5}Mn_{1.5}O₄ (LMNO) positive electrode and a lithium titanate (LTO) negative electrode (LMNO/LTO), against the specific capacity of a rechargeable battery having an LMNO positive electrode and a SPAN negative electrode (LMNO/SPAN) normalized by the mass of the LMNO for the first charge/discharge cycle.

FIG. 4B is a plot comparing the specific energy between the conventional prior art rechargeable battery having a LiNi_{0.5}Mn_{1.5}O₄ (LMNO) positive electrode and a lithium titanate (LTO) negative electrode (LMNO/LTO), against the specific capacity of a rechargeable battery having an LMNO positive electrode and a SPAN negative electrode (LMNO/SPAN) for the first charge/discharge cycle, where the specific energy is normalized by the mass of active materials in both electrodes.

FIG. 4C is a plot comparing the specific capacity as a function of the number of charge/discharge cycles of a conventional prior art rechargeable battery having a LiNi_{0.5}Mn_{1.5}O₄ (LMNO) positive electrode and a lithium titanate (LTO) negative electrode (LMNO/LTO), against a rechargeable battery having an LMNO positive electrode and a SPAN negative electrode (LMNO/SPAN), where the specific capacity is normalized by the mass of the LMNO.

FIG. 4D is a plot comparing the specific energy as a function of the number of charge/discharge cycles between a conventional prior art rechargeable battery having a LiNi_{0.5}Mn_{1.5}O₄ (LMNO) positive electrode and a lithium titanate (LTO) negative electrode (LMNO/LTO), against a rechargeable battery having an LMNO positive electrode and a SPAN negative electrode (LMNO/SPAN), where the specific energy is normalized by the mass of active materials in both electrodes.

FIG. 5 is a chart comparing calculations of the specific energy theoretically achievable with the SPAN composite negative electrode against that of conventional graphite and lithium titanate (LTO) negative electrodes, shown for positive electrodes formed from either 5 V spinel LiNi_{0.5}Mn_{1.5}O₄ or Li-rich layered Li_{1.2}Ni_{0.3}Mn_{0.6}O_{2.1}.

Similar reference characters denote corresponding features consistently throughout the attached drawings.

### BEST MODE(S) OF CARRYING OUT THE INVENTION

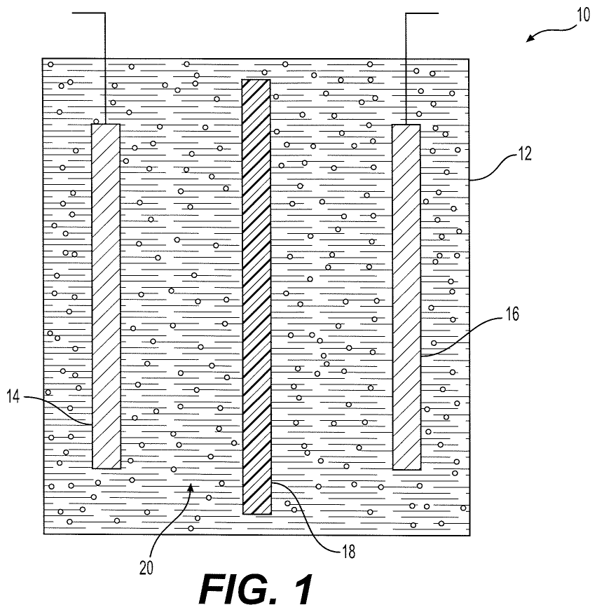

The lithium-sulfur rechargeable battery 10 includes a negative electrode 14 formed from a composite of sulfurized polyacrylonitrile (SPAN), carbon black and carbon nanofibers coated on an aluminum substrate (i.e., an aluminum current collector). As shown in FIG. 1, the negative electrode 14, a corresponding positive electrode 16, an electrolyte 20, and a separator 18 are each disposed within a cell housing 12. The positive electrode 16 is a strongly oxidizing intercalation material (e.g., a layered compound or spinel structure, or orthophosphates) formed from an alkali metal, an alkaline earth metal or salts thereof. The alkali metal of the positive electrode 16 may be, for example, lithium, sodium, potassium or cesium, and the alkaline earth metal of the positive electrode 16 may be, for example, magnesium, calcium or barium. Alternatively, the positive electrode 16 may be formed from aluminum, silver, or zinc, or in some embodiments, from hydrogen. For a lithium-based positive electrode, the positive electrode 16 may be formed from spinel-type lithium oxides (e.g., (LiNi_{0.5}Mn_{1.5}O₄ or LiNi_{0.4}Mn_{1.6}O₄), layered lithium oxides (e.g., of the type xLi₂MnO₃.(1-x)Li(Mn, Co, Ni)O₂, or lithium orthophosphates (e.g., LiCoPO₄ or LiNiPO₄). The metal of the positive electrode 16 is selected such that the positive active material thereof has an electrochemical potential of at least 4.0 V relative to the alkali metal, and more preferably at least 4.5 V relative to the alkali metal.

The electrolyte 20 is formed from an alkali metal salt dissolved in an organic solvent. The alkali salt may be, for example, a lithium salt, a sodium salt, a potassium salt or a cesium salt. For example, the electrolyte used in testing, as will be described in detail below, was a 1 M solution of lithium hexafluorophosphate (LiPF₆) in a mixture of ethylene carbonate (EC) and diethyl carbonate (DEC). The separator 18 used in testing was a 25 μm thick polypropylene film.

In order to prepare the negative electrode 14, 1 g of polyacrylonitrile (PAN) was mixed with 0.05 g of multi-walled carbon nanotubes, 0.05 g of Ketjenblack carbon powder, and 5 g of elemental sulfur. The mixture was heated under inert atmosphere (nitrogen gas) up to 550° C. and left to react for six hours. After cooling down, the SPAN composite material obtained was purified by heating under vacuum at 300° C. This SPAN composite was further processed into the negative electrode 14 by mixing the SPAN (80 wt %) with carbon black (5 wt %), hydrophilic carbon nanofibers (5 wt %) and a polyacrylic acid-polyvinyl acid binder (10 wt %) in water. The slurry was cast into a film onto an aluminum current collector, and the electrode laminate was then dried at 100° C. for four hours, and then at 150° C. for one additional hour.

Other suitable transition metal compounds that may be used with lithium in the positive electrode include spinel-type oxides (LiNi_{0.5}Mn_{1.5}O₄ and LiNi_{0.4}Mn_{1.6}O₄), layered oxides of the type xLi₂MnO₃.(1-x)Li(Mn,Ni,Co)O₂ (also expressed as xLi₂MnO₃-(1-x)LiMO₂ where M is Mn, Ni, or Co and 0<x<1), and orthophosphates (LiCoPO₄ or LiNiPO₄).

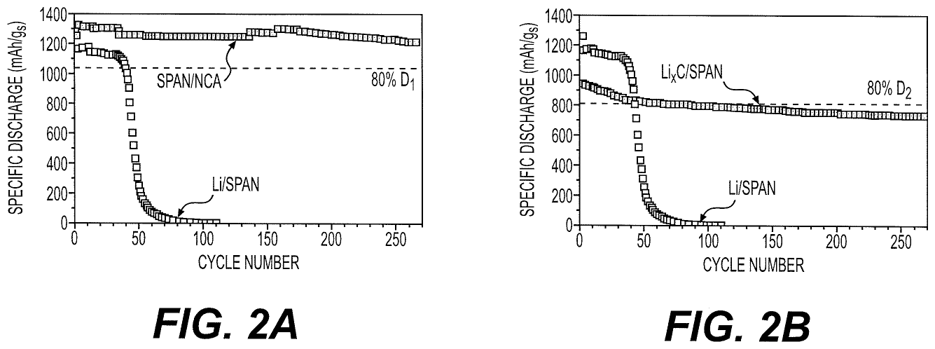

FIG. 2A compares the capacity cycling performance of a rechargeable battery having a lithium-nickel-carbon-aluminum (LiNi_{0.8}Co_{0.15}Al_{0.05}O₂) positive electrode and the SPAN composite negative electrode 14 (SPAN/NCA), against the capacity cycling performance of a conventional prior art rechargeable battery having a lithium negative electrode and a SPAN-based positive electrode (Li/SPAN). Similarly, FIG. 2B compares the capacity cycling performance of a rechargeable battery having a lithiated graphite (LiₓC) negative electrode and a SPAN composite positive electrode (LiₓC/SPAN), against the capacity cycling performance of the conventional prior art rechargeable battery with a lithium negative electrode and a SPAN-based positive electrode (Li/SPAN). The current rate used was C/5, i.e., 335 mA/gₛ. FIGS. 2A and 2B show that using lithium as the negative electrode has an adverse effect on the cycling life of the rechargeable battery. This is aggravated in conventional lithium ion rechargeable batteries by the use of too much lithium (usually greater than 300% more than needed) and by the use of too much electrolyte (usually more than ten times the amount needed). These factors decrease the specific energy (i.e., W h/kg) and add excess weight to the battery. The lithium metal carries safety risks, and the electrolyte decomposes at the surface of the lithium at every charge/discharge cycle.

By contrast, as shown in FIGS. 2A and 2B, the SPAN electrode, whether used as the negative electrode with layered or spinel positive electrode (FIG. 2A), or as the positive electrode with a lithiated graphite negative electrode (FIG. 2B) and a reasonable amount of electrolyte, results in extended cycling performance. Although the lithiated graphite as negative electrode with SPAN as positive electrode results in reasonable recycling performance, there are problems associated with the use of lithiated graphite as the negative electrode. First, neither graphite nor SPAN host alkali cations in their pristine form, and therefore one or the other would need to be pre-intercalated under inert atmosphere. Second, lithiated graphite has low intercalation potential and the associated risk of lithium plating. Third, the output voltage of a graphite/SPAN cell is rather low (around 1.5 V), and there is not much room for improvement.

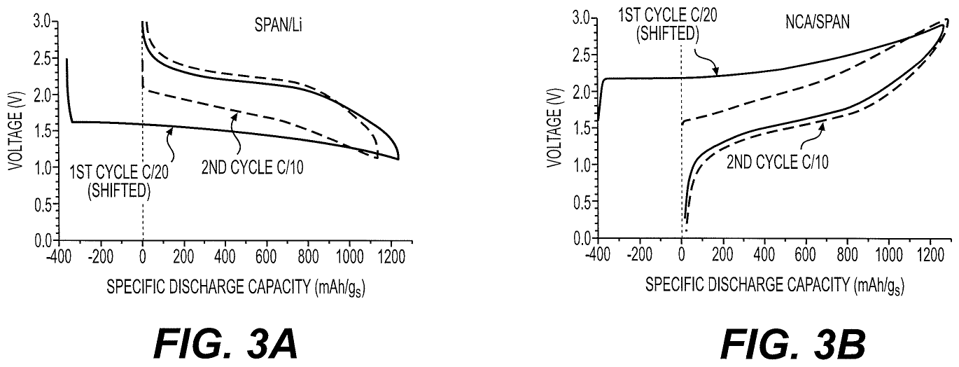

Using SPAN as the negative electrode allows assembling full Li-ion cells with high voltage positive electrode material. FIG. 3A illustrates the galvanostatic profile for a rechargeable battery having a metallic lithium negative electrode and a SPAN composite positive electrode (SPAN/Li). On the other hand, FIG. 3B illustrates the galvanostatic profile for a rechargeable battery having a lithium-nickel-carbon-aluminum (LiNi_{0.5}Co_{0.15}Al_{0.05}O₂) positive electrode and a SPAN composite negative electrode (NCA/SPAN). For both cases, the current rates are C/20; i.e., 84 mA/g, for the first cycle, and C/10; i.e., 168 mA/g, for the second cycle. It is noted that the output voltage in FIG. 3B is close to the output voltage in FIG. 3A, which suggests that the LiNi_{0.8}Co_{0.15}Al_{0.05}O₂ electrode has a voltage at the lower end of the scale as compared to metallic lithium. Other intercalated lithium electrodes used as positive electrodes have a higher voltage differential compared to lithium metal and will produce cell output voltages greater than 2.8 V.

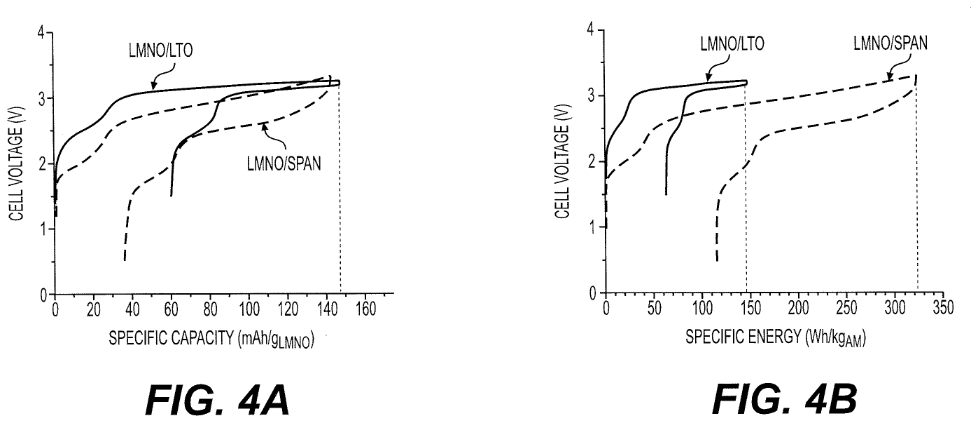

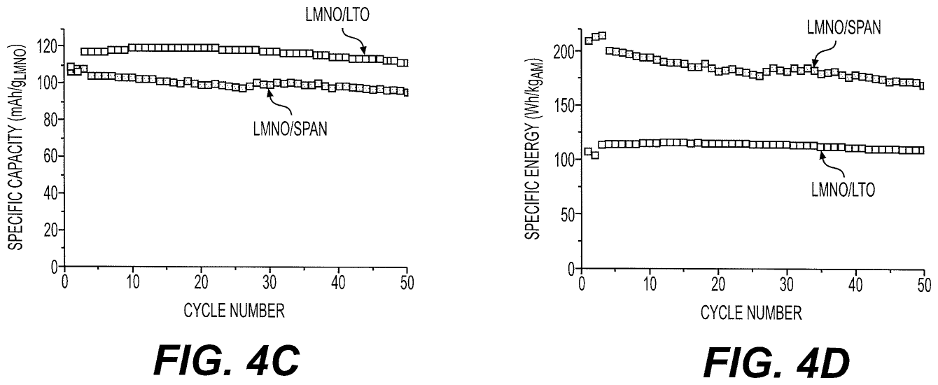

FIGS. 4A-4D compare the cycling performance between a rechargeable battery having a LiNi_{0.5}Mn_{1.5}O₄ (LMNO) positive electrode and a lithium titanate (LTO) negative electrode (LMNO/LTO) against the cycling performance of a rechargeable battery having a LiNi_{0.5}Mn_{1.5}O₄(LMNO) positive electrode and a SPAN composite negative electrode (LMNO/SPAN). FIG. 4A shows the comparison in terms of first cycle galvanostatic cell voltage as a function of specific capacity, normalized by the mass of LMNO, and FIG. 4B shows the comparison in terms of first cycle galvanostatic cell voltage as a function of specific energy, normalized by the mass of active materials in both electrodes (AM). Cyclability is shown over 50 cycles in FIG. 4C, showing the evolution of specific capacity, normalized by the mass of LMNO, as a function of the number of cycles, and in FIG. 4D, showing the evolution of specific energy, normalized by the mass of active materials in both electrodes (AM), as a function of the number of cycles. For all cases, the current rates are C/10, i.e., 15 mA/g_{LMNO} for the first cycle, and C/5, i.e., 30 mA/g_{LMNO} for the following cycles. In FIG. 4A, the LMNO/LTO battery only shows 59% Coulombic efficiency at the first cycle, whereas the LMNO/SPAN battery has a 74% efficiency. As seen in FIG. 4B, the LMNO/LTO battery only has an 83 Wh/kg reversible specific energy, while the LMNO/SPAN battery has a reversible specific energy of 208 Wh/kg. There is an approximately 10-fold increase in specific capacity when using the SPAN composite negative electrode. Similarly, there is approximately a two-fold increase in specific energy when using the SPAN composite negative electrode.

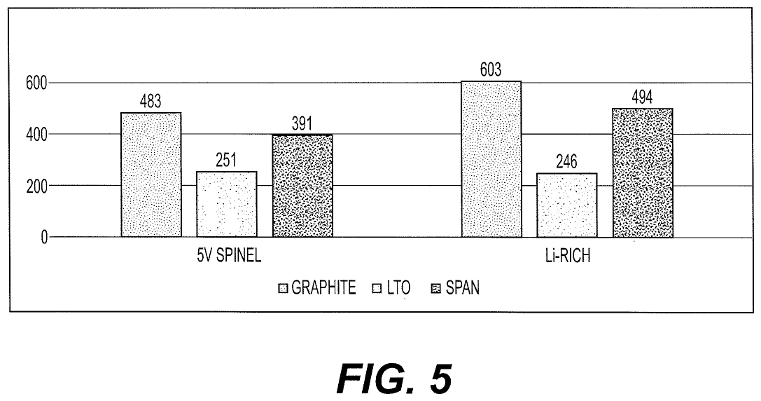

FIG. 5 shows the specific energy theoretically achievable with the SPAN composite negative electrode compared against that of conventional graphite and lithium titanate (LTO) negative electrodes, shown for positive electrodes formed from 5 V spinel LiNi_{0.5}Mn_{1.5}O₄ or the lithium-rich layered Li_{1.2}Ni_{0.3}Mn_{0.6}O_{2.1} electrode. Although the overall specific energy remains lower when the SPAN negative electrode is used compared to a graphite negative electrode, the reactivity of full cells is expected to be greatly diminished, especially in the charged state, thus rendering the lithium-sulfur rechargeable battery a safer alternative. Comparing LTO and SPAN-based negative electrodes, the two-fold increase in specific energy observed experimentally (in FIGS. 4A-4D) is also expected for any high voltage positive electrode material. Additional benefits expected from the sulfurized polymer compared to LTO are reduced gassing during cycling, resulting in improved safety, and a significantly lower production cost.

It is to be understood that the lithium-sulfur rechargeable battery is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A rechargeable battery, comprising a secondary battery having:
a negative electrode comprising a conductive polymer matrix having elemental sulfur covalently bound thereto;
a positive electrode having an intercalated metal selected from the group consisting of an alkali metal, an alkaline earth metal, and salts thereof; and
an electrolyte, the negative electrode and the positive electrode being at least partially disposed in the electrolyte, the electrolyte comprising an alkali metal salt dissolved in an organic solvent.

2. The rechargeable battery according to claim 1, wherein said negative electrode comprises a composite of sulfurated polyacrylonitrile, carbon black, and carbon nanofibers cast onto an aluminum support.

3. The rechargeable battery as recited in claim 1, wherein the alkali metal is selected from the group consisting of lithium, sodium, potassium and cesium.

4. The rechargeable battery as recited in claim 1, wherein the alkaline earth metal is selected from the group consisting of magnesium, calcium, and barium.

5. The rechargeable battery according to claim 1, wherein said alkali metal comprises lithium.

6. The rechargeable battery according to claim 5, wherein said intercalated metal comprises a lithium oxide having a spinel structure, a layered lithium oxide, or a lithium orthophosphate.

7. The rechargeable battery according to claim 1, wherein said positive electrode has a voltage of at least 4 Volts relative to a Li⁺/Li electrode.

8. The rechargeable battery as recited in claim 3, wherein the alkali metal salt is selected from the group consisting of a lithium salt, a sodium salt, a potassium salt and a cesium salt.

9. The rechargeable battery as recited in claim 1, wherein the electrolyte comprises lithium hexafluorophosphate dissolved in a mixture of ethylene carbonate and diethyl carbonate.

10. The rechargeable battery as recited in claim 1, further comprising a separator positioned between the negative electrode and the positive electrode.

11. The rechargeable battery as recited in claim 10, wherein the separator comprises a polypropylene film.

12. A lithium-sulfur rechargeable battery, comprising a secondary battery having:
a negative electrode comprising a composite of sulfurated polyacrylonitrile, carbon black, and carbon nanofibers cast onto an aluminum support;
a positive electrode having an intercalated lithium compound selected from the group consisting of a lithium oxide having a spinel structure, a layered lithium oxide, or a lithium orthophosphate; and
an electrolyte, the negative electrode and the positive electrode being at least partially disposed in the electrolyte, the electrolyte comprising an alkali metal salt dissolved in an organic solvent.

13. The lithium-sulfur rechargeable battery according to claim 12, wherein said positive electrode has a voltage of at least 4 Volts relative to a Li⁺/Li electrode.

14. The lithium-sulfur rechargeable battery according to claim 12, wherein said intercalated lithium compound is a lithium oxide having a spinel structure selected from the group consisting of LiNi_{0.5}Mn_{1.5}O₄ and LiNi_{0.4}Mn_{1.6}O₄.

15. The lithium-sulfur rechargeable battery according to claim 12, wherein said intercalated lithium compound is a layered lithium oxide having the formula xLi₂MnO₃.(1-x)LiMO₂ where M is Mn, Ni, or Co and 0<x<1.

16. The lithium-sulfur rechargeable battery according to claim 12, wherein said intercalated lithium compound is an orthophosphate selected from the group consisting of LiCoPO₄ and LiNiPO₄.

17. A rechargeable battery, comprising a secondary battery having:
a negative electrode comprising a composite of sulfurized polyacrylonitrile, carbon black and carbon nanofibers coated on an aluminum substrate;
a positive electrode comprising a metal selected from the group consisting of aluminum, silver, zinc, hydrogen, and salts thereof; and
an electrolyte comprising an alkali metal salt dissolved in an organic solvent, the positive and negative electrodes being at least partially disposed in the electrolyte.

18. The rechargeable battery as recited in claim 17, wherein the electrolyte comprises lithium hexafluorophosphate dissolved in a mixture of ethylene carbonate and diethyl carbonate.
